(19) United States
(12) Patent Application Publication
(10) Pub. No.: US 2007/0229959 A1
(43) Pub. Date: Oct. 4, 2007

(54) Light Box Barrier System for a Projection Display

(76) Inventors: Scott Joseph Duggan, Indianapolis, IN (US); Darin Bradley Ritter, Indianapolis, IN (US); Patrick Thomas Whitsett, Greenwood, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/587,299

(22) PCT Filed: Apr. 26, 2005
(86) PCT No.: PCT/US05/14236

§ 371 Date: Oct. 23, 2006

Related U.S. Application Data
(60) Provisional application No. 60/566,371, filed on Apr. 29, 2004.

(51) Int. Cl. H04N 5/64; G02B 27/00

(52) U.S. Cl. 359/601; 348/842; 348/E05.128

(57) ABSTRACT

A projection display with a shield surrounding an output end of a light engine to prevent dust and stray light from entering a light box of the projection display is described. The projection display includes a cabinet, a light engine mounted in the cabinet and having an output end and an electronic end, a removable front cover mounted on the cabinet covering the light engine, and a shield surrounding the light engine between the output end and the electronic end.

### CROSS-REFERENCE TO RELATED APPLICATIONS

This application claims the benefit of U.S. Provisional Patent Application Ser. No. 60/566,371, entitled “Light Box Barrier System for a Projection Display” and filed Apr. 29, 2004, which is incorporated by reference herein in its entirety.

### FIELD OF THE INVENTION

The invention relates generally to a projection display and, in particular to a light engine for a projection display.

### BACKGROUND OF THE INVENTION

Projection display televisions typically have a problem keeping dust out the enclosed area containing the lens, screen and mirrors hereinafter called a light box. Also, stray light from the lamp assembly can enter the light box, degrading performance of the projection television. Sealing this compartment is most difficult where the light projector is mounted to the cabinet. The need to seal out dust and stray light is compounded on newer generation “Slim DLP” sets that use “upangle” optics systems. With the shallow, glancing angles of the raypath off the mirrors, dust particles cast larger shadows and, hence, reduce picture performance.

Some microdisplay projection displays utilize a foam seal that merely seals around the barrel of the lens as it passes through an opening in the light box enclosure. Due to geometry constraints in the Slim DLP set the barrier needs to be installed after the light engine is in place and also needs to be able to accommodate small rotational adjustments of the light engine.

### SUMMARY OF THE INVENTION

According to an exemplary embodiment of the invention, a projection display is provided with a shield surrounding a light engine to prevent dust from entering a light box of the projection display. The projection display comprises a cabinet or chassis, a light engine mounted in the cabinet having an output end and an electronic end, a removable front cover mounted on the cabinet covering the light engine, and a shield surrounding said output end of said light engine. A receiving groove is formed in the cabinet, surrounding the light engine. The shield has a first edge mounted in the receiving groove.

### BRIEF DESCRIPTION OF THE DRAWING FIGURES

The preferred embodiments of the present invention will be described with reference to the accompanying drawing figures, of which:

FIGS. 1A and 1B are perspective front views of a projection display according to an exemplary embodiment of the present invention, with FIG. 1A shown with a front panel removed to show a light engine of the projection display and FIG. 1B shown with a screen removed to show a light box;

FIG. 2 is a detail perspective front view of the projection display of FIGS. 1A and 1B, shown with the front panel in place;

FIG. 3 is a detailed perspective front view of the projection display of FIGS. 1A, 1B, and 2, shown with the front panel removed;

FIG. 4 is an exploded front view of the projection display of FIGS. 1A, 1B, 2, and 3;

FIG. 5 is a detailed front view of a light engine and barrier of a projection display according to an exemplary embodiment of the present invention; and

FIG. 6 is a detailed sectional view of the projection display of FIGS. 1A, 1B, 2, 3, 4, and 5 with the light engine omitted for clarity.

### DETAILED DESCRIPTION

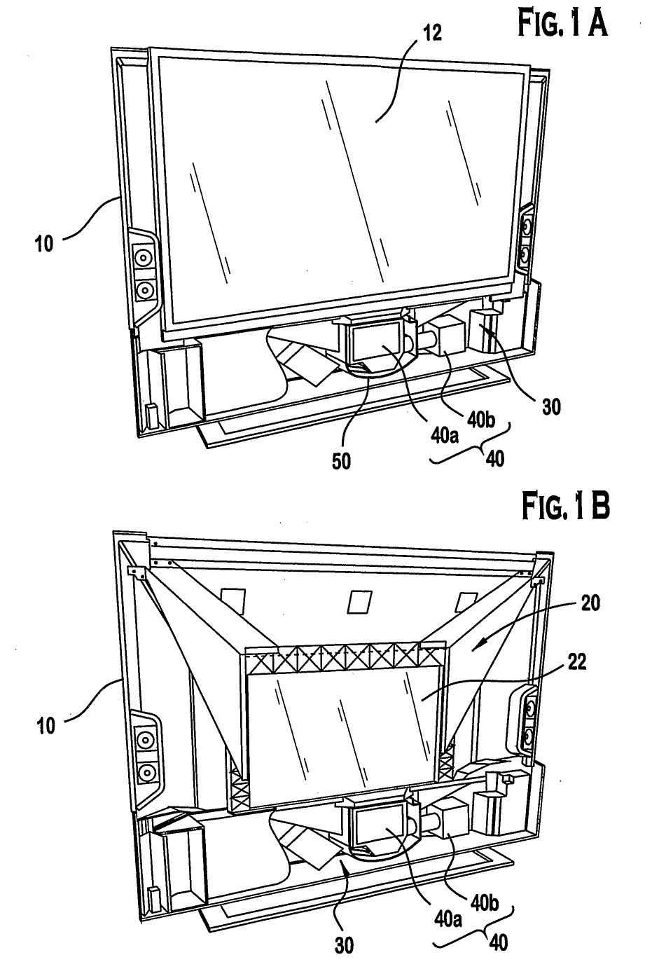

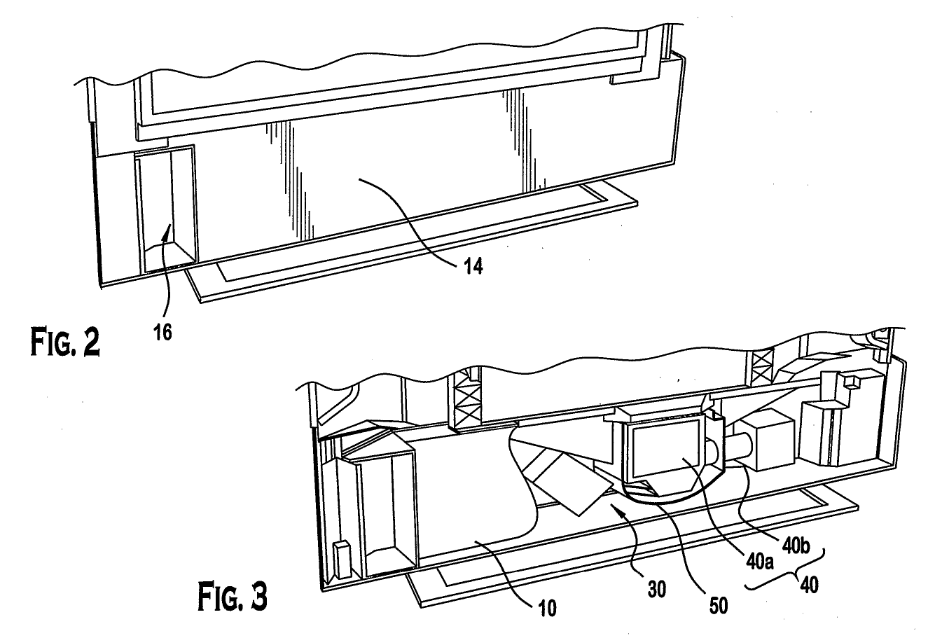

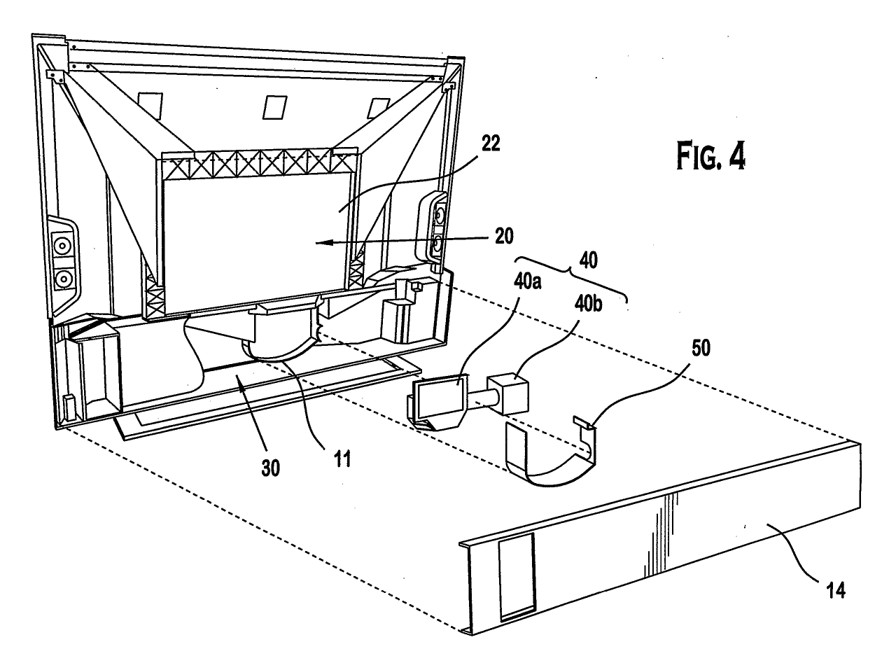

According to an exemplary embodiment of the invention, a projection display is provided with a shield surrounding a light engine to prevent dust from entering a light box of the projection display. As shown in FIGS. 1A and 1B, the projection display comprises a cabinet 10 that is formed from a molded plastic and comprises a electronic area 30 and a light box 20. A light engine 40 comprises an output end 40a from which a light pattern is projected and an electronic end 40b having a lamp and various electronic components therein. The light engine 40 is mounted with the output end 40a in the light box 20 of the cabinet 10 and with the electronic end 40b in the electronic area 30. As shown in FIG. 1A a screen 12 is mounted over the light box 20

A removable front cover 14 (shown in FIG. 2) covers the light engine 40 and the electronic area 30, when it is installed on the cabinet 10.

A shield 50 is installed surrounding the output end 40a of the light engine 40. The shield 50 extends from the back of the cabinet 10 to front panel 14 (when it is installed), blocking dust and stray light from the electronic area 30 from entering the light box 20.

As best shown in FIG. 6, the cabinet 10 has a receiving groove 11 formed therein. This receiving groove 11 may, for example, be molded into the cabinet at a location that surrounds the mounted location of the output end 40a of the light engine 40.

In the exemplary embodiments illustrated in the figures, the shield 50 comprises resiliently deformable sheet stock. The sheet stock may be plastic or metal, having sufficient flexibility to be deformed by hand into a shape that surrounds the output end 40a of the light engine 40 and fits at an edge thereof into the receiving groove 11. The sheet stock may be die cut, for example, to achieve the desired size and configuration to surround the output end 40a of the light engine 40 and fit into the receiving groove 11.

The shield 50 is configured such that when curled by hand, it fits tightly around the adjacent surfaces of the light engine 40 at a location between the output end 40a and the electronic end 40b and around portions of the cabinet and slips into the receiving groove 11 in the main cabinet where it is temporarily retained. In an exemplary embodiment of the invention, a receiving groove 11 is provided on the cabinet to receive the light engine 40, and the shield 50 fits tightly to this receiving groove 11.

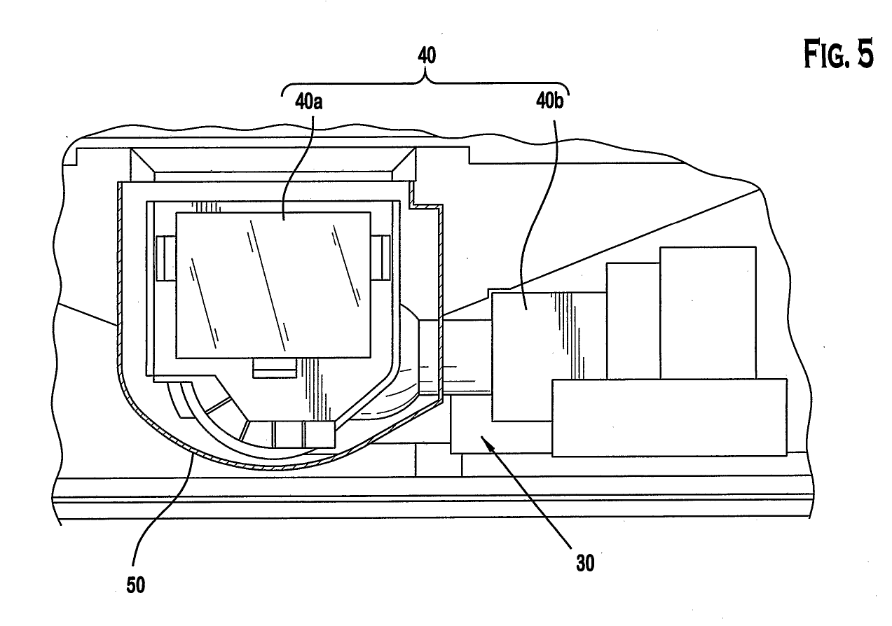

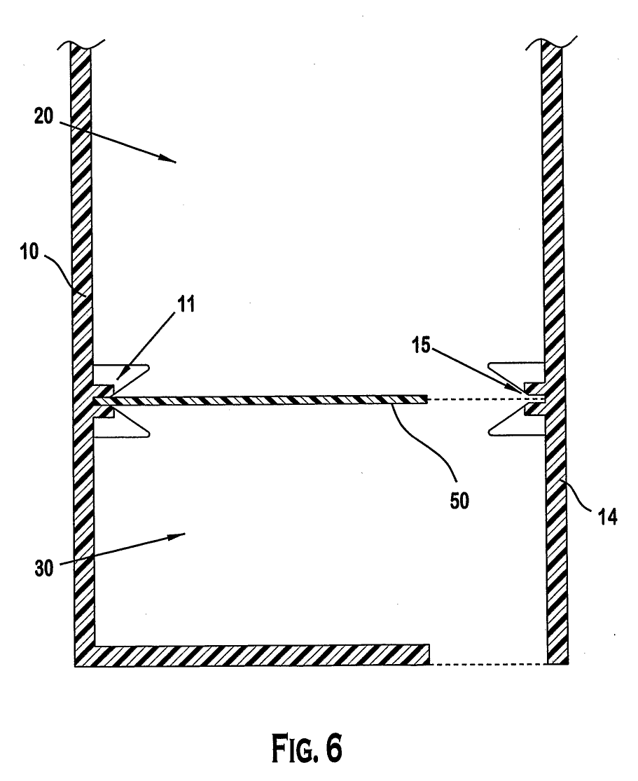

As best seen in FIGS. 5 and 6, the shield 50 extends from a back wall of the cabinet 10 to the front of the cabinet 10, separating the light box 20 from the electronic area 30. Thus, dust and stray light present in the electronic area 30 can not enter the light box 20, where it would adversely effect the performance of the projection display.

The front cover 14, as shown in FIG. 6, may have a channel or groove 15 formed in its inside face to receive a second edge of the shield 50 opposite the first edge, when the front cover 14 is installed on the cabinet 10. The groove 15 may be formed as a continuous channel or may be formed between two ribs, for example. The front cover 14 is positioned over the light engine 40 with the groove 15 aligned to the shield 50, and the front cover 14 is then attached to the cabinet 10. In an exemplary embodiment of the invention, the front cover 14 is removably attached to the cabinet 10 so that it can be removed for servicing, providing access to the light engine 40 from the front of the projection display, thereby facilitating service.

Attaching the front cover 14 creates a sandwich (cabinet 10, shield 50, and front cover 14), which effectively forms a barrier keeping dust laden cooling air and stray light that enters the electronics area 30 of the cabinet 10 from being transmitted into the light box 20.

Die cut sheet stock parts are inherently low cost and have low tooling costs compared to injection molded or sheet metal parts. The die cut sheet stock also has the benefit of “nesting” well which reduces the volume of space required for inventory. Moreover, because the sheet stock is resiliently deformable, the shield 50 can be fitted into the cabinet after the light engine 40 has been installed and can also allow adjustment of the light engine, after it is in place.

In the illustrated projection display the cabinet 10 has an electronic area 30 with electronics mounted therein and a light box 20 with a mirror 22 mounted therein and a light path therethrough. The light engine 40 is mounted with the output end 40a in the light box 20, and the electronic end 40b in the adjacent the electronic area 30. The shield 50 is inserted at a first edge into the receiving groove 11, formed, for example, in an inner surface of a back wall of the cabinet 10 and projecting forward to separate the electronic area 30 from the light box 20 at the light engine 40. A seal conforming to the surface of the light engine 40 may also be provided to provide enhanced sealing of the light engine 40 to the shield 50, the cabinet 10, or both.

When the front cover 14 is installed on the cabinet 10, it forms a sandwich with the cabinet 10 to hold the shield 50 between the front cover and the cabinet.

1. A projection display, comprising:
a cabinet;
a light engine mounted in said cabinet; said light engine having an output end and an electronics end;
a receiving groove formed in said cabinet, surrounding said output end of said light engine; and
a shield surrounding said output end of said light engine; said shield having a first edge mounted in said receiving groove.

2. The projection display of claim 1, further comprising a removable front cover mounted on said cabinet covering said light engine; wherein said front cover has a groove formed therein and said shield has a second edge opposite said first edge which is received in said groove in said front cover.

3. The projection display of claim 2, wherein the front cover is removably fastened to the cabinet and the light engine is accessible from the front of the projection display with the front cover removed.

4. The projection display of claim 1, wherein said shield comprises resiliently deformable sheet stock.

5. The projection display of claim 1, wherein a seal is provided adjacent the light engine conforming to an outside surface of the light engine.

6. A shield arrangement for isolating an electronic area of a projection display from a light box of the projection display, the shield arrangement comprising:
a cabinet having a light engine with an output end disposed in the light box and an electronic end disposed in the electronic area;
a receiving groove formed in the cabinet surrounding the output end of the light engine; and
a resiliently flexible shield having a first edge inserted in the receiving groove and projecting around the light engine between the electronic area and the light box.

7. The shield arrangement of claim 6, wherein the shield is held in the receiving groove by a front cover attached to the cabinet.

8. The shield arrangement of claim 7, wherein the front cover has a groove formed therein to receive a second edge of the shield opposite the first edge.

9. The shield arrangement of claim 6, wherein the shield comprises sheet stock having sufficient flexibility to be deformed to fit around the light engine by hand.
